(19) United States
(12) Patent Application Publication
(10) Pub. No.: US 2017/0211727 A1
(43) Pub. Date: Jul. 27, 2017

(54) PIPE CONNECTING STRUCTURE

(71) Applicant: Harda (Xiamen) Plastic Co., Ltd., Xiamen City (CN)

(72) Inventor: Kesheng Peng, Xiamen City (CN)

(21) Appl. No.: 15/229,018

(22) Filed: Aug. 4, 2016

(30) Foreign Application Priority Data
Jan. 26, 2016 (CN) 201610050962.7

(51) Int. Cl. F16L 13/02; B29C 65/00; B29C 65/16

(52) U.S. Cl. CPC F16L 13/0209; B29C 65/16; B29C 66/5221

(57) ABSTRACT

A pipe connecting structure includes a tube made of PERT (polyethylene of raised temperature resistance) or PEX (crosslinked polyethylene) having a light-pervious or light-absorption color and a tubular connector made of PP (polypro pylene), PE (poly ethylene), POM (polyformaldehyde) or PA (polyamide) having a light-absorption or light-pervious color. One end of the tube and one end of the tubular connector are mated with each other to be welded together by laser welding with parameters including a power in the range of 13-28 W and a rotational speed in the range of 45-50 rpm. The strength of the pipe connecting structure is up to 500 psi when making a burst pressure test. The strength of the pipe connecting structure is two-three times as much as the original PERT tubular connector.

### BACKGROUND OF THE INVENTION

1. Field of the Invention

The present invention relates to a water pipe fitting, and more particularly to a pipe connecting structure.

2. Description of the Prior Art

PERT pipes are non-crosslinked polyethylene pipes used in hot water piping systems, which are also medial density polyethylene pipes and have the features of high temperature resistance, good flexibility, pressure resistance, non-toxic, odorless, non-pollution, low temperature resistance, and so on. PERT is suitable for a water pipe assembly material. Nowadays, the water pipe assembly is made of PERT instead of a copper material, so that the material cost and the manufacturing cost of the parts are lowered greatly. Because the water pipe assembly made of a copper material may harm to health, the water pipe assembly made of PERT has been widely used on the market.

In general, the connecting structure of pipes includes a metallic connector or a metal fitting to wrap the joint of a plastic tube and a plastic connector. This structure provides a better sealing function in the beginning, but it may have a leak at the joint after a period of time due to the hard metal. Besides, its burst resistance and pressure resistance are not perfect.

Therefore, an improved connecting structure is developed on the market. The connecting structure includes a PERT plastic pipe and a PERT plastic connector which are connected by laser welding. This connecting structure provides a better sealing and connecting function, but the PERT plastic connector is soft. The joint is not strong enough, so it is not durable for use. Accordingly, the inventor of the present invention has devoted himself based on his many years of practical experiences to solve these problems.

### SUMMARY OF THE INVENTION

The primary object of the present invention is to provide a pipe connecting structure which is cost-effective, durable and safe.

In order to achieve the aforesaid object, the pipe connecting structure of the present invention comprises a tube made of PERT (polyethylene of raised temperature resistance) or PEX (crosslinked polyethylene) having a light-absorption color and a tubular connector made of PP (polypro pylene), PE (poly ethylene), POM (polyformaldehyde) or PA (polyamide) having a light-pervious color; or comprises a tube made of PERT (polyethylene of raised temperature resistance) or PEX (crosslinked polyethylene) having a light-pervious color and a tubular connector made of PP (polypro pylene), PE (poly ethylene), POM (polyformaldehyde) or PA (polyamide) having a light-absorption color. One end of the tube and one end of the tubular connector are mated with each other to be welded together.

Preferably, the end of the tubular connector is formed with a two-grade stepped hole corresponding to an outer diameter of the end of the tube. The two-grade stepped hole includes a small hole and a big hole which are arranged from inside to outside in an axial direction of the tubular connector. The end of the tube is fitted in the big hole of the two-grade stepped hole. The tubular connector is made of a light-pervious material. The tube is made of a light-absorption material.

Preferably, the end of the tube is coupled to the big hole by an interference fit.

Alternatively, the end of the tube is formed with a two-grade stepped hole corresponding to an outer diameter of the tubular connector. The two-grade stepped hole includes a small hole and a big hole which are arranged from inside to outside in an axial direction of the tube. The end of the tubular connector is fitted in the big hole of the two-grade stepped hole. The tube is made of a light-pervious material. The tubular connector is made of a light-absorption material.

Preferably, the end of the tubular connector is coupled to the big hole by an interference fit.

Preferably, the interference fit has a unilateral tolerance in the range of 0-0.10 mm.

Preferably, the unilateral tolerance is in the range of 0-0.08 mm.

Preferably, the PP or PE contains 15-20% glass fibers.

Preferably, the end of the tube and the end of the tubular connector are welded together by laser welding with parameters comprising a power in the range of 13-28 W and a rotational speed in the range of 45-50 rpm.

Preferably, the power is 18 W and the rotational speed is 45 rpm.

Accordingly, the tubular connector made of PP, PE, POM or PA and the tube made of PERT of the present invention are mated with each other, and they can be preferably welded together. PP, PE, POM or PA is harder than PERT and can be welded with PERT better. After they are welded together, the strength is up to 500 psi when making a burst pressure test. The tensile strength and modulus of the PERT is in the range of one third to a half of the tensile strength and modulus of the PP or PE. After laser welding, the strength of the connecting structure of the same structure is two-three times as much as the original PERT tubular connector.

### BRIEF DESCRIPTION OF THE DRAWINGS

FIG. 1 is a sectional view according to an embodiment of the present invention; and

FIG. 2 is a sectional view according to another embodiment of the present invention.

### DETAILED DESCRIPTION OF THE PREFERRED EMBODIMENTS

Embodiments of the present invention will now be described, by way of example only, with reference to the accompanying drawings.

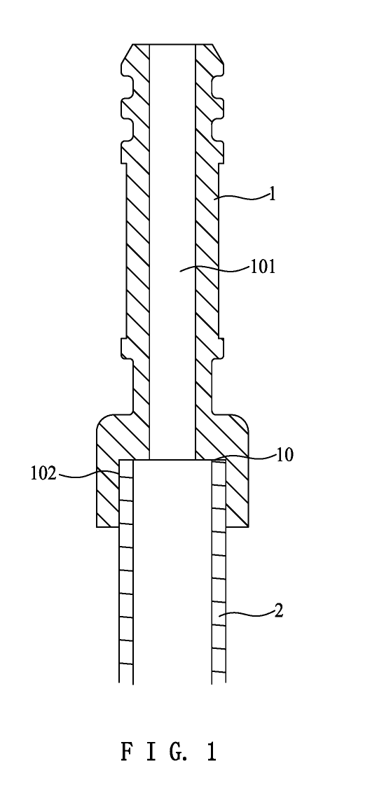

As shown in FIG. 1, the present invention discloses a pipe connecting structure. The pipe connecting structure comprises a tubular connector 1 and a tube 2 fitted to the tubular connector 1. The tubular connector 1 is made of PP (polypro pylene), PE (poly ethylene), POM (polyformaldehyde) or PA (polyamide) having a light-pervious color. The tube 2 is made of PERT (polyethylene of raised temperature resistance) or PEX (crosslinked polyethylene) having a light-absorption color (preferably, black). The tubular connector 1 and the tube 2 are coupled together by laser welding. The laser welding is governed by the parameters comprising a power in the range of 13-28 W and a rotational speed in the range of 45-50 rpm. Preferably, the power is 18 W and the rotational speed is 45 rpm. The strength of the pipe connecting structure of the present invention is up to 500 psi when making a burst pressure test.

In a preferred embodiment, one end of the tubular connector 1 is formed with a two-grade stepped hole 10. The two-grade stepped hole 10 includes a small hole 101 and a big hole 102 which are arranged from inside to outside in an axial direction of the tubular connector 1. One end of the tube 2 is fitted in the big hole 102 of the two-grade stepped hole 10. The end of the tube 2 is coupled to the big hole 102 by an interference fit with a unilateral tolerance in the range of 0-0.10 mm. Preferably, the unilateral tolerance is in the range of 0-0.08 mm. The joint of the tube 2 and the tubular connector 1 has a certain prepressing force, which greatly strengthens mutual heat contact during laser welding.

Preferably, the tubular connector 1 is made of PP or PE. In a preferred embodiment, the PP or PE contains 15-20% glass fibers. Preferably, the tube 2 is made of PERT. The tensile strength and modulus of the PERT is in the range of one third to a half of the tensile strength and modulus of the PP or PE. After laser welding, the strength of the connecting structure of the same structure is two-three times as much as the original PERT tubular connector.

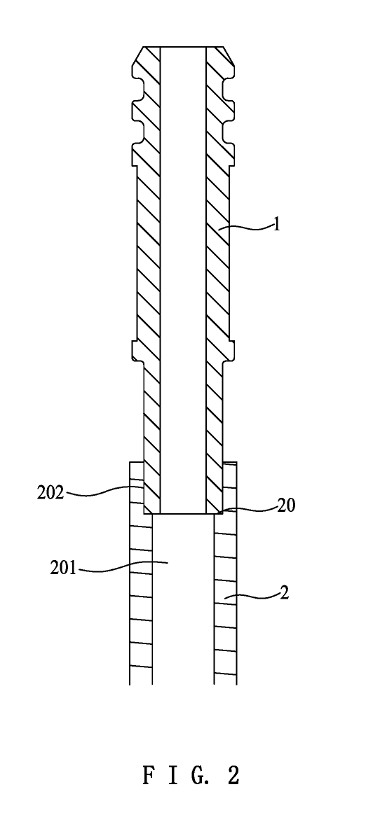

Referring to FIG. 2, one end of the tube 2 of the present invention may be formed with a two-grade stepped hole 20. The two-grade stepped hole 20 includes a small hole 201 and a big hole 202 which are arranged from inside to outside in an axial direction of the tube 2. One end of the tubular connector 1 is fitted in the big hole 202 of the two-grade stepped hole 20. The tubular connector 1 is made of PP (polypro pylene), PE (poly ethylene), POM (polyformaldehyde) or PA (polyamide) having a light-absorption color (preferably, black). The tube 2 is made of PERT (polyethylene of raised temperature resistance) or PEX (crosslinked polyethylene) having a light-pervious color. The end of the tubular connector 1 is coupled to the big hole 202 by an interference fit with a unilateral tolerance in the range of 0-0.10 mm. Preferably, the unilateral tolerance is in the range of 0-0.08 mm. The joint of the tube 2 and the tubular connector 1 has a certain prepressing force, which greatly strengthens mutual heat contact during laser welding.

Thereby, the tubular connector 1 made of PP, PE, POM or PA and the tube 2 made of PERT of the present invention are mated with each other, and they can be preferably welded together. PP, PE, POM or PA is harder than PERT and can be welded with PERT better. After they are welded together, the strength is up to 500 psi when making a burst pressure test. The tensile strength and modulus of the PERT is in the range of one third to a half of the tensile strength and modulus of the PP or PE. After laser welding, the strength of the connecting structure of the same structure is two-three times as much as the original PERT tubular connector.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pipe connecting structure, comprising a tube made of PERT (polyethylene of raised temperature resistance) or PEX (crosslinked Polyethylene) having a light-absorption color and a tubular connector made of PP (polypro pylene), PE (poly ethylene), POM (polyformaldehyde) or PA (polyamide) having a light-pervious color; or comprising a tube made of PERT (polyethylene of raised temperature resistance) or PEX (crosslinked polyethylene) having a light-pervious color and a tubular connector made of PP (polypro pylene), PE (poly ethylene), POM (polyformaldehyde) or PA (polyamide) having a light-absorption color, one end of the tube and one end of the tubular connector being mated with each other to be welded together.

2. The pipe connecting structure as claimed in claim 1, wherein the end of the tubular connector is formed with a two-grade stepped hole corresponding to an outer diameter of the end of the tube, the two-grade stepped hole comprises a small hole and a big hole which are arranged from inside to outside in an axial direction of the tubular connector; the end of the tube is fitted in the big hole of the two-grade stepped hole, the tubular connector is made of a light-pervious material, and the tube is made of a light-absorption material.

3. The pipe connecting structure as claimed in claim 2, wherein the end of the tube is coupled to the big hole by an interference fit.

4. The pipe connecting structure as claimed in claim 3, wherein the interference fit has a unilateral tolerance in the range of 0-0.10 mm.

5. The pipe connecting structure as claimed in claim 4, wherein the unilateral tolerance is in the range of 0-0.08 mm.

6. The pipe connecting structure as claimed in claim 1, wherein the end of the tube is formed with a two-grade stepped hole corresponding to an outer diameter of the tubular connector, the two-grade stepped hole comprises a small hole and a big hole which are arranged from inside to outside in an axial direction of the tube; the end of the tubular connector is fitted in the big hole of the two-grade stepped hole, the tube is made of a light-pervious material, and the tubular connector is made of a light-absorption material.

7. The pipe connecting structure as claimed in claim 6, wherein the end of the tubular connector is coupled to the big hole by an interference fit.

8. The pipe connecting structure as claimed in claim 7, wherein the interference fit has a unilateral tolerance in the range of 0-0.10 mm.

9. The pipe connecting structure as claimed in claim 8, wherein the unilateral tolerance is in the range of 0-0.08 mm.

10. The pipe connecting structure as claimed in claim 1, wherein the PP or PE contains 15-20% glass fibers.

11. The pipe connecting structure as claimed in claim 1, wherein the end of the tube and the end of the tubular connector are welded together by laser welding with parameters comprising a power in the range of 13-28 W and a rotational speed in the range of 45-50 rpm.

12. The pipe connecting structure as claimed in claim 11, wherein the power is 18 W, and the rotational speed is 45 rpm.
